(19) United States
(12) Patent Application Publication
(10) Pub. No.: US 2016/0072278 A1
(43) Pub. Date: Mar. 10, 2016

(54) Field Device having a Protection Circuit

(71) Applicant: ENDRESS+HAUSER FLOWTEC AG, Reinach (BL) (CH)

(72) Inventors: Daniel Kollmer, Lorrach (DE); Matthias Brudermann, Moehlin (CH); Frank Bonschab, Rummingen (DE); Heinz Muller, Fulda (DE); Nikolai Fink, Aesch (CH)

(21) Appl. No.: 14/782,646

(22) PCT Filed: Feb. 17, 2014
(86) PCT No.: PCT/EP2014/052994

§ 371 Date: Oct. 6, 2015

(30) Foreign Application Priority Data
Apr. 11, 2013 (DE) 10 2013 103 627.9

(51) Int. Cl. H02H 9/02

(52) U.S. Cl. CPC H02H 9/02

(57) ABSTRACT

A field device comprising a protection circuit between a communication interface and a signal processing unit. A communication interface is preferably an Ethernet connection of the field device, wherein between the communication interface and the signal processing unit a first system is provided, which serves for electrical current limiting, wherein between the first system for electrical current limiting and the signal processing unit a means is provided, which serves for voltage limiting, and wherein between the means for voltage limiting and the signal processing unit a second system is provided, which serves for energy limiting.

The invention relates to a field device of process automation technology, which field device includes a protection circuit. The invention relates also to a protection circuit per se, as well as to a method for safe isolation of intrinsically safe, electrical current circuits from non-intrinsically safe, electrical current circuits, or for safe isolation of intrinsically safe, electrical current circuits from intrinsically safe, electrical current circuits.

Field devices are applied in industrial plants for controlling and/or monitoring processes.

Such field devices often use a wired connection, in order to connect to a fieldbus or, in general, to any electrical line serving for energy supply of the field device and/or for transmission of data from, respectively to, the field device. Such connections, often also referred to as fieldbus connections, serve, for example, for communication by means of a protocol used for data transmission, such as, for example, a HART, Profibus, Foundation Fieldbus, etc. protocol. Recently, also so-called Ethernet connections are used for data transmission by means an industrial Ethernet protocol.

Additionally, field devices can make use of an additional connection, via which an energy supply of the field device and/or a transmission of data from, respectively to, the field device are/is enabled. Also in this case, the connection can be an Ethernet connection.

It is thus possible to connect field devices permanently to an Ethernet network, so that the communication with a field device for control and/or monitoring of the process occurs via the Ethernet network.

On the other hand, for example, service devices can be connected to a field device for only a short time via an additional connection (referred to as a service connection), in order to service the field device. “Servicing”, in such case, refers to any kind of data exchange with the field device, especially for the purpose of parametering, for loading a new firmware or simply for the read-out of data from the field device, such as, for example, data in the form of measurement data recorded by the field device.

In the case of an ignitable, or explosive, process environment, for example, when an ignitable gas is used in in the process, it is additionally required to provide a limiting of the electrical power transmitted to the field device in the case of malfunction. Corresponding measures and guidelines are provided in standards, such as IEC 60079-11 (also known as Ex) or the Class I, Division 1, respectively 2 with the groups A, B, C or D holding for North America.

In the case of malfunction in the above described field device configurations, up to 260V, respectively, in general, the available grid voltage, to which, for example, a service device is connected, can lie on the corresponding connections of the field device.

Some service devices, especially conventional devices, such as laptops, tablets, etc., often possess, however, no corresponding measures for power limiting.

An object of the invention, consequently, is to provide corresponding measures, in order to prevent damaging of the field device or in order to prevent an energy input, which lies above a predetermined value, especially above a predetermined ignition voltage, especially in the case of malfunction.

The object is achieved according to the invention by a field device, a protection circuit and a method.

As regards the field device, the object is achieved by a field device of process automation technology comprising a protection circuit between a communication interface of the field device and a signal processing unit of the field device, wherein the communication interface is preferably an Ethernet connection of the field device, wherein between the communication interface and the signal processing unit a first system is provided, which serves for electrical current limiting, wherein between the first system for electrical current limiting and the signal processing unit a means is provided, which serves for voltage limiting, and wherein between the means for voltage limiting and the signal processing unit a second system is provided, which serves for energy limiting.

In general, Ethernet interfaces offer advantages as regards the transmission speed of data as well as an inherent galvanic isolation. The galvanic isolation, however, does not meet the above-mentioned intrinsic safety standards, such as e.g. IEC 60079-11, when conventional components are applied. The proposed invention remedies this situation. It is, thus, possible by means of any conventional device to establish a safe connection with the field device even in the case of malfunction.

It is, however, also an option to use interfaces other than the mentioned Ethernet interface for data transmission from, respectively to, the field device. Options, in such case, include all interfaces used in the field of automation technology, especially process automation, for energy supply of a field device and/or communication with the field device. Some examples, such as HART etc. have already been named above.

Through corresponding design of the applied components of the protection circuit, i.e. the first system, the second system and the means for voltage limiting, an isolation between the field device and a service device, respectively the communication interface, meeting the ignition protection type, intrinsic safety, for example, Ex i IIA, IIB or IIC or the above-mentioned Class I, Division 1, respectively 2 in groups A, B, C or D can be assured.

Especially preferably, the protection circuit between the communication interface and the signal processing unit is composed of the first system for electrical current limiting, the second system for energy limiting and the means for voltage limiting, i.e. there are no additional components present other than the mentioned components, in order to achieve a sufficient isolation corresponding to a standard, preferably the ATEX guidelines.

To this point in time, for a corresponding maintenance of a field device via the communication interface of the field device, the process had to be paused, respectively the explosion susceptible atmosphere “switched off”, for example, by removing the ignitable process medium, even though the sensor, in given cases, was separated, i.e. remote, from the communication interface and/or from the signal processing unit and located in the explosion dangerous environment.

The proposed solution is superior to the solutions known from the state of the art especially because optical transmission does not have to be relied on and no special integrated circuits (ICs) have to be used. Thus, the costs for such a protection circuit can be lessened, the form of construction is smaller and also the energy consumption of the protection circuit is lessened.

In a form of embodiment of the field device, the first system for electrical current limiting preferably includes a first capacitor pair and serves to limit the electrical energy, which can be input via the interface, in order to protect the means for voltage limiting.

In given cases, also only a single capacitor, two capacitors or more than two capacitors, for example, three, four, five or six or more capacitors, can be used. In the case of multiple capacitors, i.e., for example, in the case of two capacitors, i.e. a capacitor pair, these are preferably connected in series. The capacitors are, in such case, preferably embodied in such a manner that they possess the dielectric strength required by the specifications of IEC 60079-11 or Class 1, Division 1, respectively 2 group A, B, C or D and fulfill the corresponding creep path specifications, i.e. the capacitors, preferably each capacitor, possess/possesses a corresponding form of construction.

In an additional form of embodiment of the field device, the second system for energy limiting includes a second capacitor pair, which serves to limit the electrical energy, corresponding to a predetermined limit value, for example, corresponding to the specifications of the ignition protection type, intrinsic safety. The embodiments mentioned in regard to the first system for electrical current limiting hold mutatis mutandis also for the second system for electrical current-, respectively energy limiting.

In an additional form of embodiment of the field device, the first system for electrical current limiting serves, for example, in the case of malfunction, to protect the means for voltage limiting against an energy input via the communication interface with grid voltage, respectively the disturbance voltage present in the case of malfunction. Thus, by the electrical current limiting of the first system, which is arranged between the communication interface and the means for voltage limiting, the power and, thus, the energy input into the field device, especially the energy conversion, which is present in the means for voltage limiting, can be limited. In this way, the functionality of the means for voltage limiting and that of the second system for energy limiting can be assured.

In a preferred form of embodiment, the means for voltage limiting includes at least one diode, especially preferably at least one Zener diode. Via the means for voltage limiting, thus, an occurring disturbance voltage lying above a threshold value can be turned away. Preferably, the means for voltage limiting is connected with protective earth.

In an additional form of embodiment of the field device, the first system for electrical current limiting fulfills the specifications of the ignition protection type, intrinsic safety, and is matched to the means for voltage limiting.

The means for voltage limiting can be so embodied and matched in such a manner to the first system for electrical current limiting that the power converted in the means for voltage limiting is less than the allowable power, which is permitted to be converted by the means for voltage limiting. This requires naturally a mutual design of used components. For example, a capacitor serving for electrical current limiting can be so designed that the power converted in a diode serving for voltage limiting is less than the maximum power allowable in the diode. Preferably, the capacitor, i.e., in general, the system for electrical current limiting, is so designed that in the case of malfunction, the voltage applied to the diode, i.e., in general, the means for voltage limiting, amounts to, for example, only ⅔ of the maximum allowable power in the means for voltage limiting. In this way, a reliable protection and, thus, a reliable action of the means for voltage limiting can be assured in the case of malfunction.

In an additional form of embodiment of the field device, the first system for electrical current limiting serves to limit the electrical energy, respectively the electrical power, of a (disturbance-)voltage present (on the communication interface) in the case of malfunction. The power of a voltage lying on the communication interface in the case of defect is regulated, furthermore, by the means for voltage limiting.

In an additional form of embodiment of the field device, the means for voltage limiting and the second system for energy limiting serve to limit the energy input via the protection circuit to below 50 μJ (fifty microjoule). This corresponds to the requirements of a standard for explosion protection, such as e.g. IEC 60079-11 or the above-mentioned Class 1, Division 1, respectively 2 for an explosion-endangered zone such as, for example, zone 0, zone 1, zone 2 in the gas group IIA, IIB or IIC.

In an additional form of embodiment of the field device, the communication interface is connected with the signal processing unit via at least one signal line, wherein the signal line extends via the first system for electrical current limiting and the second system for energy limiting, and wherein the signal line extends via the means for voltage limiting.

The means for voltage limiting includes preferably at least one diode, preferably a correspondingly designed Zener diode, which, on the one side, is connected with protective earth and, on the other side, with the at least one signal line.

The communication interface can also be connected with the signal processing unit via a number of signal lines. Corresponding connections can be provided on the communication interface and the signal processing unit, so that a signal line serves to transmit a corresponding signal from one of the connections on the communication interface to a corresponding connection on the signal processing unit. For example, the signal lines can serve for data transmission between the communication interface and a service device, in given cases connected thereto, and the signal processing unit according to the full-duplex principle, preferably the full-duplex Ethernet principle. For example, a differential signal can be transmitted via a first signal line Tx+ and a second signal line Tx− via the communication interface to the signal processing unit. A differential signal from the signal processing unit can be transmitted via a third signal line Rx+ and a fourth signal line Rx− via the communication interface and corresponding connections to a service device in given cases connected thereto.

However, yet other connections, for example, a connection predetermined by the Ethernet standard, can be provided on the communication interface. Correspondingly, also yet more signal lines can be provided between the communication interface and the signal processing unit. In this form of embodiment, at least one of the signal lines, preferably, however, each of the signal lines or at least the above signal lines referenced with Tx+, Tx−, Rx+, Rx−, is/are provided with a first system for electrical current limiting, a second system for energy limiting and a means for voltage limiting. Each of the signal lines can thus comprise a first system for electrical current limiting, which preferably is composed of at least two capacitors connected in series according to the above described form of construction, a second system for energy limiting, which is likewise composed preferably of at least two capacitors connected in series, and a means for voltage limiting (located between the first and second systems for electrical current-, respectively energy, limiting), which is composed preferably of a corresponding diode, preferably a Zener diode (compare further below). The first system for electrical current limiting and the second system for energy limiting are, in such case, likewise connected in series between the communication interface and the signal processing unit, wherein the means for voltage limiting is connected between the first and second systems for electrical current-, respectively energy, limiting, on the one hand, with the corresponding signal line and, on the other hand, with protective earth. The particular diode serving for voltage limiting, preferably a Zener diode, is, in such case, preferably connected in the blocking direction between the corresponding signal line and the protective earth. Alternatively for this purpose, a blocking diode can be used in the conduction direction.

The means for voltage limiting can be connected with, in each case, a signal line via, in each case, at least one corresponding diode. Preferably, however, all diodes connected with a signal line are connected via a single diode with protective earth, which single diode is connected in the conduction direction between the signal lines and the protective earth, so that it is connected in the blocking direction with the protective earth.

In an additional form of embodiment of the field device, thus, the first and second systems for electrical current-, respectively energy, limiting are connected in series, and the means for voltage limiting is arranged between the series connected first and second systems for electrical current-, respectively energy, limiting.

The second system for energy limiting is preferably designed in such a manner that the power, respectively energy, output from it to the signal processing unit is limited according to the ignition protection type, intrinsic safety. Of advantage, in such case, is that in the case of malfunction (i.e., for example, there is lying on the communication interface a disturbance voltage, which corresponds, for example, to the grid voltage), now no longer does the disturbance voltage get to the second system for energy limiting, which, for example, comprises two capacitors, but, instead, only the voltage limited by the means for voltage limiting. The (continuous) functionality of this means for voltage limiting is, in turn, assured by the first system for electrical current limiting.

In an additional form of embodiment of the field device, there is provided between the protection circuit and the signal processing unit a means for potential isolation, preferably so-called magnetics. The means for galvanic isolation, i.e. potential isolation, is, thus, preferably arranged between the second system for electrical current limiting and the signal processing unit.

In the case of a plurality of signal lines, in such case, each signal line can be connected with the means for potential isolation via a corresponding channel and further via these channels with the signal processing unit.

In an additional form of embodiment of the field device, the signal processing unit is an operating electronics of the field device, wherein the signal processing unit is connected, for example, with a sensor electronics, which sensor electronics is preferably arranged separated, i.e. locally isolated, from the signal processing unit. Separated, i.e. locally isolated, means, in such case, that the signal processing unit and the sensor, respectively the sensor electronics, have, in each case, their own housings.

As regards the protection circuit, the object is achieved by a protection circuit for a field device as claimed in one of the preceding claims. The protection circuit includes, respectively is composed of, preferably a first system for electrical current limiting and a second system for energy limiting as well as a means for voltage limiting, such as above described.

As regards the method, the object is achieved by a method for safe isolation of intrinsically safe from non-intrinsically safe or of intrinsically safe from intrinsically safe, electrical current circuits, wherein the power of a voltage lying on a communication interface of a field device is limited by a first system for electrical current limiting, wherein the voltage applied on the communication interface is limited by a means for voltage limiting, and wherein the energy provided through this limited voltage is limited by a second system for energy limiting, preferably according to the requirements of the ignition protection type, intrinsic safety.

The invention will now be explained in greater detail based on the appended drawing, the sole FIGURE of which shows as follows:

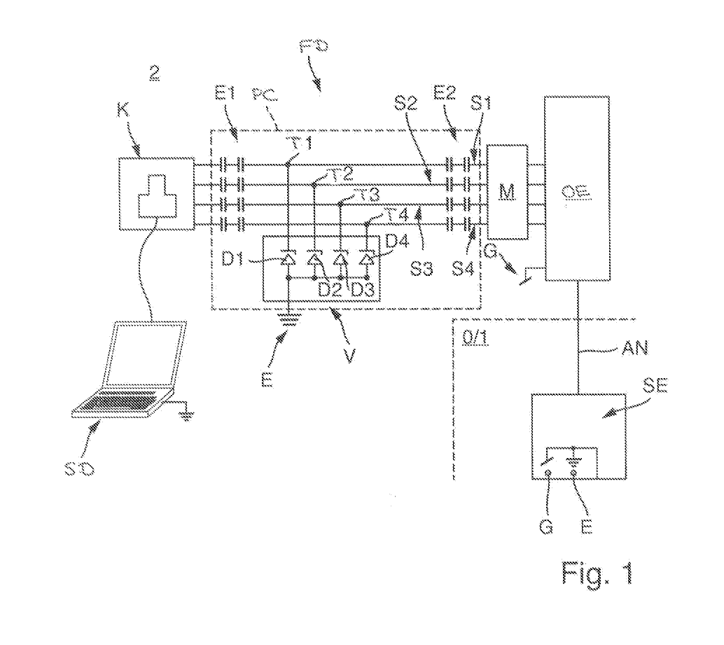

FIG. 1 a schematic representation of the protection circuit between a service device and an operating electronics of a field device.

FIG. 1 shows a schematic representation of a (mobile) preferably hand-holdable, service device SD, here a laptop, which is connected via a communication interface K with an operating electronics OE of a field device FD.

The field device FD of FIG. 1 includes removed from the operating electronics OE a sensor electronics SE, which serves for preprocessing the measurement signals delivered by a sensor. The sensor as well as the sensor electronics SE are located, in such case, in an explosion-endangered zone, for example, a zone 0 or zone 1.

The sensor electronics SE is connected with the operating electronics OE via a signal line AN for transmission of the measurement signals in digital or analog form. In the case of malfunction, there could occur via the communication interface K, thus, into the explosion-endangered zone 0/1, an energy input, which lies above the allowable energy input permitted for these zones according to the relevant standard.

For limiting the electrical energy enterable via the communication interface K, there is provided between the communication interface K and the operating electronics OE a protection circuit PC for energy-, respectively power, limiting.

The communication interface K includes connections for establishing a connection with the operating electronics OE. The communication interface K can be, for example, a plugged connection, in the case of which besides an electrical connection between the service device SD and the field device FD also a mechanical connection of the connecting line with the field device FD occurs.

According to FIG. 1, corresponding connections are provided, in order to exchange data in the form of differential signals in full-duplex operation between the service device SD and the operating electronics OE of the field device FD. Instead of the shown communication interface K, which is designed for the short time servicing of the field device FD in the sense of a service interface, it can, in such case, also be a communication interface K, which is designed for long-term operation of the field device FD and for data exchange via a fieldbus, i.e. a so-called permanent wiring.

In the shown form of embodiment, the communication interface K is connected with the operating electronics OE via four signal lines S1, S2, S3, S4. There can also be other signal lines, not shown. Each of the signal lines S1, S2, S3, S4 includes a first pair and a second pair of capacitors, wherein the first pair forms the first system E1 for electrical current limiting and the second pair the second system E2 for energy limiting.

Furthermore, each of the signal lines S1, S2, S3, S4 includes a tap T1, T2, T3, T4 between the first and second capacitor pairs, via which each signal line S1, S2, S3, S4 is connected with protective earth E via at least one diode D1, D2, D3, D4 connected here in the blocking direction. These diodes D1, D2, D3, D4 can likewise be designed redundantly, i.e. instead of, for example, the diode D1, a number of diodes are connected in series.

Each of the branches emanating at the tap T1, T2, T3, T4 from the respective signal line S1, S2, S3, S4 includes a diode D1, D2, D3, D4.

Provided between the second capacitor pair and the signal processing unit in the form of the operating electronics OE is a galvanic isolation M in the form of so-called magnetics.

The proposed invention effectively enables isolation of an intrinsically safe explosion endangered region 0/1 from a non-intrinsically safe region 2, since the proposed measures durably and reliably prevent an energy- or power input into the explosion-endangered region 0/1. The explosion-endangered region 0/1 is indicated in FIG. 1 by the dashed lines and the protection circuit PC by the dotted lines.

A first capacitor pair limits the power of a voltage lying on a communication interface K of a field device FD, wherein the voltage applied to the communication interface K is limited by the diodes D1, D2, D3, D4, and wherein the energy, respectively power, provided by this limited voltage is limited by means of the second capacitor pair, preferably according to the requirements of the ignition protection type, intrinsic safety.

### LIST OF REFERENCE CHARACTERS

0/1 explosion endangered, respectively intrinsically safe, zone
2 non-intrinsically safe zone
SD service device
K communication interface
E1 first system for electrical current limiting
E2 second system for energy limiting
V means for voltage limiting
E protective earth
G ground
S1 first signal line
S2 second signal line
S3 third signal line
S4 fourth signal line
M galvanic isolation
OE operating electronics
SU sensor unit
FD field device
AN signal line between sensor/sensor electronics and operating electronics
PC protection circuit
D1 first diode
D2 second diode
D3 third diode
D4 fourth diode
D5 fifth diode

1-13. (canceled)

14. A field device of process automation technology comprising:
a signal processing unit;
a protection circuit; located between a communication interface of the field device and said signal processing unit of the field device, wherein:
said communication interface is preferably an Ethernet connection of the field device;
between said communication interface and said signal processing unit a first system is provided, which serves for electrical current limiting;
between said first system for electrical current limiting and said signal processing unit a means is provided, which serves for voltage limiting; and
between said means for voltage limiting and said signal processing unit a second system is provided, which serves for energy limiting.

15. The field device as claimed in claim 14, wherein:
said first system for electrical current limiting preferably includes a first capacitor pair and serves to limit the electrical energy, which can be input via said interface, in order to protect said means for voltage limiting.

16. The field device as claimed in claim 14, wherein:
said second system for energy limiting includes a second capacitor pair, which serves to limit the electrical power corresponding to the specifications of the ignition protection type, intrinsic safety.

17. The field device as claimed in claim 14, wherein:
said first system for electrical current limiting serves to protect said means for voltage limiting against an energy input via said interface with a disturbance voltage, especially grid voltage.

18. The field device as claimed in claim 14, wherein:
said first system for electrical current limiting fulfills the specifications of the ignition protection type, intrinsic safety and is matched to the diodes of said means for voltage limiting.

19. The field device as claimed in claim 14, wherein:
the electrical power of a voltage applied in the case of a malfunction is limited by means of said first system for electrical current limiting.

20. The field device as claimed in claim 14, wherein:
said means for voltage limiting and said second system serve to limit the energy input via a protection circuit to below 50 μJ (fifty microjoule).

21. The field device as claimed in claim 14, wherein:
said interface is connected with said signal processing unit via at least one signal line;
said at least one signal line extends via said first system and said second system for energy limiting; and
said at least one signal line extends via said means for voltage limiting.

22. The field device as claimed in claim 14, wherein:
said first and said second systems are connected in series for electrical current limiting; and
said means for voltage limiting is arranged between said series connected first system for electrical current limiting and said second system for energy limiting.

23. The field device as claimed in claim 20, wherein:
there is provided between said protection circuit and said signal processing unit a means for potential isolation, preferably so-called magnetics.

24. The field device as claimed in claim 14, wherein:
said signal processing unit is an operating electronics of the field device;
said signal processing unit is connected with a sensor electronics, which sensor electronics is preferably arranged separated, i.e. locally isolated, from the operating electronics.

25. A protection circuit for a field device, comprising: a signal processing unit; a protection circuit; located between a communication interface of the field device and said signal processing unit of the field device, wherein: said communication interface is preferably an Ethernet connection of the field device; between said communication interface and said signal processing unit a first system is provided, which serves for electrical current limiting; between said first system for electrical current limiting and said signal processing unit a means is provided, which serves for voltage limiting; and between said means for voltage limiting and said signal processing unit a second system is provided, which serves for energy limiting.

26. A method for safe isolation of intrinsically safe from non-intrinsically safe electrical current circuits or intrinsically safe from intrinsically safe electrical current circuits, wherein the power of a voltage lying on a communication interface of a field device is limited by a first system for electrical current limiting, wherein the voltage applied on the communication interface is limited by a means for voltage limiting, and wherein the power provided by this limited voltage is limited by a second system for energy limiting, preferably according to the requirements of the ignition protection type, intrinsic safety.
